(19) United States
(12) Patent Application Publication
(10) Pub. No.: US 2025/0139024 A1
(43) Pub. Date: May 1, 2025

(54) MEMORY SYSTEM AND A METHOD FOR TRANSMITTING DATA THROUGH A COMMAND ADDRESS BUS

(71) Applicant: SK hynix Inc., Icheon-si Gyeonggi-do (KR)

(72) Inventor: Ki Cheol SON, Icheon-si Gyeonggi-do (KR)

(73) Assignee: SK hynix Inc., Icheon-si Gyeonggi-do (KR)

(21) Appl. No.: 18/582,211

(22) Filed: Feb. 20, 2024

(30) Foreign Application Priority Data
Oct. 26, 2023 (KR) 10-2023-0144611

(51) Int. Cl. G06F 13/16

(52) U.S. Cl. CPC G06F 13/1668

(57) ABSTRACT

A memory system includes a memory controller and a memory apparatus. One of the memory controller and the memory apparatus is configured to transmit, through the command address bus, data to the other one of the memory controller and the memory apparatus.

### CROSS-REFERENCES TO RELATED APPLICATION

The present application claims priority under 35 U.S.C. § 119 a to Korean application number 10-2023-0144611, filed on Oct. 26, 2023, in the Korean Intellectual Property Office, which is incorporated herein by reference in its entirety as set forth in full.

### BACKGROUND

### 1. Technical Field

Various embodiments generally relate to integrated circuit technology, more specifically, to a memory system.

### 2. Related Art

An electronic device includes a lot of electronic elements and a computer system as the electronic device includes lots of semiconductor apparatuses each configured by a semiconductor. The semiconductor apparatuses constituting the computer system may include a processor or a memory controller and a memory device or a storage device. The processor or memory controller may work as a master device and the memory device or storage device may work as a slave device. The master device may provide the slave device with a command address signal and the slave device may perform various operations in response to the command address signal. Further, the master device and the slave device may transmit data to each other.

In a NAND flash memory system, a NAND flash memory apparatus may communicate with a memory controller through various interfacing schemes. According to the NAND interfacing schemes, command address signals and data may be transmitted through the same input/output bus. As the operating frequency of the NAND flash memory system increases, the NAND interfacing schemes may cause performance degradation of the NAND flash memory system due to an increase in command overhead. According to the Serial Command Address (SCA) interfacing scheme, command address signals and data may be transmitted through different input/output buses. The command address signals may be transmitted through a command address bus and the data may be transmitted through a data bus. The SCA interfacing scheme has the advantage of reducing some command overhead and controlling multiple memory apparatuses to operate in a parallel way. However, since the transmission period of the command address signal is shorter than the transmission period of the data, the command address bus may remain idle without any activity during the long period of transmitting the data through the data bus.

### SUMMARY

In an embodiment, a memory system may include a memory controller and a memory apparatus. The memory apparatus may be coupled to the memory controller through a data bus and a command address bus. One of the memory controller and the memory apparatus may be configured to transmit, through the command address bus, data to the other one of the memory controller and the memory apparatus.

In an embodiment, an operating method of a memory system including a memory controller and a memory apparatus may include transmitting, by the memory controller, one of a data input command signal and a data output command signal to the memory apparatus through a command address bus. The method may include transmitting, by one of the memory controller and the memory apparatus, a first portion of data to the other one of the memory controller and the memory apparatus through a data bus. The method may include transmitting, by the memory controller, a mode command signal to the memory apparatus through the command address bus. And the method may include transmitting, by the one of the memory controller and the memory apparatus, a second portion of the data to the other one of the memory controller and the memory apparatus through the command address bus.

In an embodiment, a memory system may include: a memory controller; and a memory apparatus coupled to the memory controller through a data bus configured to transmit data to be programmed into the memory apparatus and a command address bus configured to transmit a command address signal, wherein the memory controller is configured to transmit a first portion of the data to be programmed into the memory apparatus to the memory apparatus through the command address bus, and wherein the memory controller is configured to transmit a second portion of the data to be programmed into the memory apparatus to the memory apparatus through the data bus.

In an embodiment, a memory system may include: a memory controller; and a memory apparatus coupled to the memory controller through a data bus configured to transmit data to be read from the memory apparatus and a command address bus configured to transmit a command address signal, wherein the memory controller is configured to transmit a first portion of the data to be read from the memory apparatus to the memory controller through the command address bus, and wherein the memory controller is configured to transmit a second portion of the data to be read from the memory apparatus to the memory controller through the data bus.

In an embodiment, an operating method of a memory system including a memory controller and a memory apparatus may be provided, the operating method comprising: transmitting a command address signal through a command address bus; transmitting a first portion of data to be programmed into the memory apparatus to the memory apparatus through the command address bus; and transmitting a second portion of the data to be programmed into the memory apparatus to the memory apparatus through a data bus.

In an embodiment, an operating method of a memory system including a memory controller and a memory apparatus may be provided, the operating method comprising: transmitting a command address signal through a command address bus; transmitting a first portion of data to be read from the memory apparatus to the memory controller through the command address bus; and transmitting a second portion of the data to be read from the memory apparatus to the memory controller through a data bus.

### BRIEF DESCRIPTION OF THE DRAWINGS

FIG. 1 is a block diagram illustrating a configuration of a memory system according to an embodiment.

FIG. 2 is a timing diagram illustrating an operation of the memory system according to an embodiment.

FIG. 3 is a timing diagram illustrating a data input operation of the memory system according to an embodiment.

FIG. 4 is a timing diagram illustrating a data output operation of the memory system according to an embodiment.

FIG. 5 is a diagram illustrating a configuration of a memory apparatus according to an embodiment.

FIG. 6 is a diagram illustrating a configuration of an embodiment of a command address buffer shown in FIG. 5.

FIG. 7 is a diagram illustrating a configuration of an embodiment of a second data input/output circuit shown in FIG. 5.

FIGS. 8A and 8B are timing diagrams illustrating an embodiment of an operation of the second data input/output circuit shown in FIG. 7.

FIG. 9 is a diagram illustrating a configuration of a memory controller according to an embodiment.

FIG. 10 is a diagram illustrating a configuration of an embodiment of a second data input/output circuit shown in FIG. 9.

### DETAILED DESCRIPTION

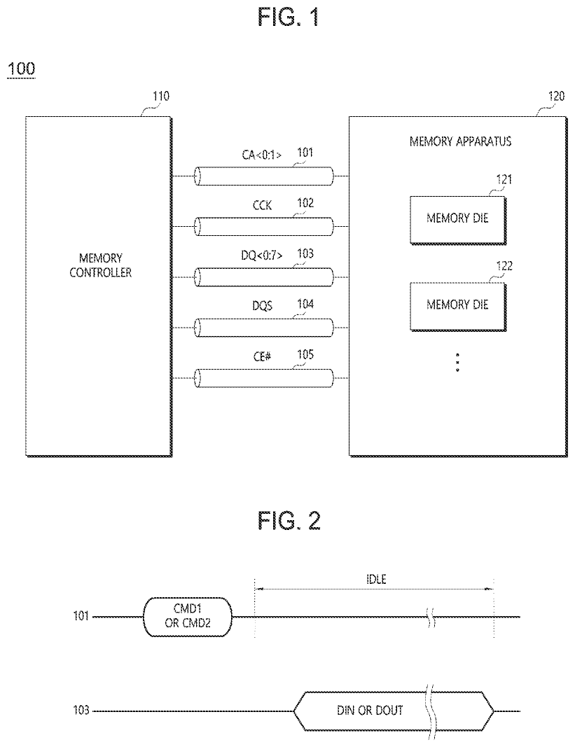

FIG. 1 is a block diagram illustrating a configuration of a memory system 100 according to an embodiment. Referring to FIG. 1, the memory system 100 may include a memory controller 110 and a memory apparatus 120. The memory controller 110 may provide the memory apparatus 120 with various control signals for the operation of the memory apparatus 120. Based on the control signals provided from the memory controller 110, the memory apparatus 120 may perform various operations. The memory apparatus 120 may perform data input and data output operations with the memory controller 110. The data input operation may be an operation of transferring data from the memory controller 110 to the memory apparatus 120. The data output operation may be an operation of transferring data from the memory apparatus 120 to the memory controller 110. For example, the memory apparatus 120 may be a flash memory apparatus, the data input operation may be a random data input operation and the data output operation may be a random data output operation. The memory apparatus 120 may include a plurality of memory dies 121 and 122. Each of the plurality of memory dies 121 and 122 may independently perform the data input operation and the data output operation.

The memory controller 110 may be coupled to the memory apparatus 120 through a plurality of buses. The plurality of buses may be signal transmission paths, links or channels for transmitting signals. The plurality of buses may include a command address bus 101, a command clock bus 102, a data bus 103, a data strobe bus 104, and a chip enable bus 105. The chip enable bus 105 may be a unidirectional bus from the memory controller 110 to the memory apparatus 120. Each of the command address bus 101, the command clock bus 102, the data bus 103, and the data strobe bus 104 may be a bidirectional bus. The memory controller 110 may provide a command address signal CA<0:1> to the memory apparatus 120 through the command address bus 101. The command address signal CA<0:1> may include a command signal and an address signal. The command signal may include command information indicating an operation that the memory apparatus 120 is to perform. The address signal may include address information for accessing a storage area of the plurality of memory dies 121 and 122 in the memory apparatus 120. For example, the memory controller 110 may provide the command address signal CA<0:1> including a data input command signal, a data output command signal and a mode command signal. In one embodiment, the mode command signal may include a first mode command signal and a second mode command signal. The memory controller 110 may transmit, per unit cycle, a 2-bit signal to the memory apparatus 120 through the command address bus 101. The command address signals CA<0:1> transmitted during a plurality of cycles may constitute a single command address signal set.

The memory controller 110 may provide a command clock signal CCK to the memory apparatus 120 through the command clock bus 102. The memory apparatus 120 may provide the command clock signal CCK to the memory controller 110 through the command clock bus 102. The command clock bus 102 may be a signal synchronized with a signal transmitted through the command address bus 101 and may be a signal defining a time section, in which the memory apparatus 120 may receive as a valid signal a signal transmitted through the command address bus 101. For example, during a time interval in which the command clock signal CCK toggles, the memory apparatus 120 may sample as a valid signal a signal transmitted from the memory controller 110 through the command address bus 101. The memory controller 110 may sample, as a valid signal, a signal transmitted from the memory apparatus 120 through the command address bus 101. Through the data bus 103, the memory controller 110 may provide data signal DQ<0:7> to the memory apparatus 120 or receive the data signal DQ<0:7> from the memory apparatus 120. For instance, the data signal DQ<0:7> may contain 8 bits and the 8-bit data signal DQ<0:7> may be transmitted through the data bus 103 per unit cycle. The data signals DQ<0:7> transmitted during a plurality of cycles may constitute a data set. The memory controller 110 may transmit the data strobe signal DQS to the memory apparatus 120 through the data strobe bus 104. The memory apparatus 120 may transmit the data strobe signal DQS to the memory controller 110 through the data strobe bus 104.

The memory controller 110 may transmit a chip enable signal CE # to the memory apparatus 120 through the chip enable bus 105. A number of bits to be included in the chip enable signal CE # may vary depending on a number of memory dies and/or memory chips included in the memory apparatus 120. For example, when the memory apparatus 120 includes two (2) memory dies or memory chips, the chip enable signal CE # may contain 1 bit or 2 bits. When the memory apparatus 120 includes four (4) memory dies or memory chips, the chip enable signal CE # may contain 2 bits or 4 bits. The memory controller 110 may provide the chip enable signal CE # to the memory apparatus 120 through the chip enable bus 105. The chip enable signal CE # may serve as a signal to identify the memory die, which is to perform an operation in response to the command address signal CA<0:1> among the plurality of memory dies included in the memory apparatus 120.

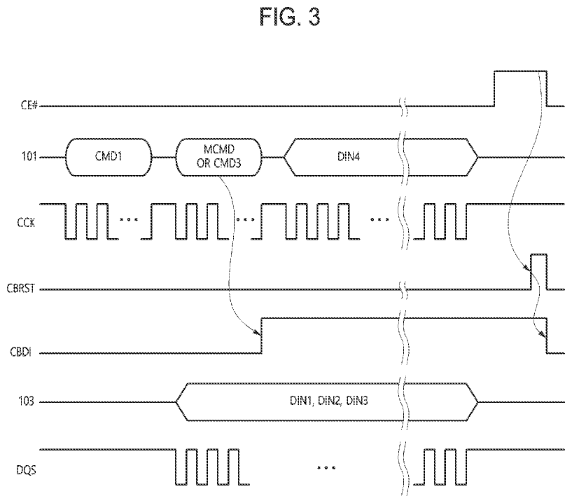

FIG. 2 is a timing diagram illustrating an operation of the memory system 100 according to an embodiment. Referring to FIGS. 1 and 2, the memory controller 110 may provide, through the command address bus 101, the memory apparatus 120 with the command address signal CA<0:1> containing a data input command signal CMD1 or a data output command signal CMD2 for a data input operation or a data output operation. After the data input command signal CMD1 or the data output command signal CMD2 is provided, data DOUT and DIN may be transmitted through the data bus 103. When the memory controller 110 provides the data input command signal CMD1, the data input operation may be performed and the memory controller 110 may transmit the data DIN to the memory apparatus 120 by transmitting the data signal DQ<0:7> through the data bus 103 during multiple unit cycles. When the memory controller 110 provides the data output command signal CMD2, the data output operation may be performed and the memory apparatus 120 may transmit the data DOUT to the memory controller 110 by transmitting the data signal DQ<0:7> through the data bus 103 during multiple unit cycles. A total number of bits for the data input command signal CMD1 or the data output command signal CMD2 may be less than a total number of bits for the data DIN and DOUT and the time interval, during which the command address signal CA<0:1> is transmitted, may be shorter than the time interval, during which the data signal DQ<0:7> is transmitted. Therefore, during the time interval during which the data signal DQ<0:7> is transmitted, the command address bus 101 may stay idle and might not transfer any information. Further, when all data is transmitted through the data bus 103, the time interval during which the data DIN and DOUT are transmitted might not be shortened. In order to efficiently use the command address bus 101 staying idle, the memory system 100 in accordance with an embodiment may transmit a data signal through the command address bus 101. In an embodiment, by transmitting the data signals through the command address bus 101, the memory system 100 may reduce the time interval during which the data DIN and DOUT are transmitted, may increase the speed of data input/output (input and output) operations and may enhance the performance of the memory system 100.

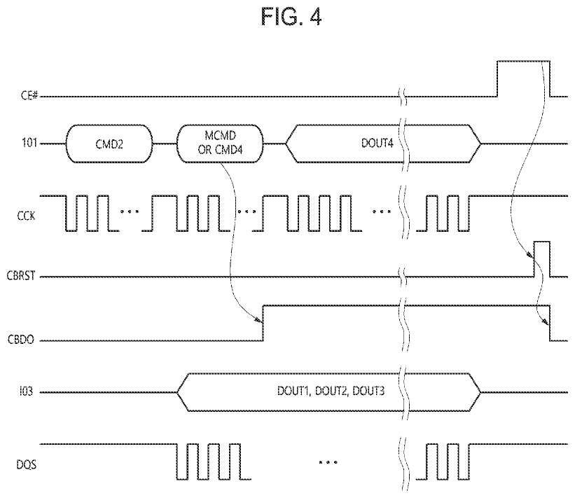

FIG. 3 is a timing diagram illustrating a data input operation of the memory system 100 according to an embodiment. Referring to FIGS. 1 and 3, the memory controller 110 may provide, through the command address bus 101, the memory apparatus 120 with the command address signal CA<0:1>, which includes the data input command signal CMD1, for the data input operation. Together with the command address signal CA<0:1>, the memory controller 110 may provide the command clock signal CCK, which is synchronized with the command address signal CA<0:1>. During the data input operation after providing the data input command signal CMD1, the memory controller 110 may provide, through the data bus 103, the memory apparatus 120 with the data DIN1 to DIN3, which is a first portion of the data DIN1 to DIN4, as the data signal DQ<0:7>. Together with the data DIN1 to DIN3 or the first portion of the data DIN1 to DIN4, the memory controller 110 may provide the data strobe signal DQS, which is synchronized with the data DIN1 to DIN3. After providing the data input command signal CMD1, the memory controller 110 may provide, through the command address bus 101, the memory apparatus 120 with the command address signal CA<0:1> including the mode command signal MCMD. Together with the command address signal CA<0:1>, the memory controller 110 may provide the command clock signal CCK, which is synchronized with the command address signal CA<0:1>. Upon receiving the data input command signal CMD1 and the mode command signal MCMD, the memory apparatus 120 may enable a first data mode signal CBDI to activate a data input/output (input and output) mode. Once the data input/output mode is activated, the command address bus 101 may become ready to transfer a data signal. In one embodiment, the mode command signal MCMD may be replaced by a first mode command signal CMD3 and the memory apparatus 120 may enable the first data mode signal CBDI upon receiving the command address signal CA<0:1> including the first mode command signal CMD3. After providing the mode command signal MCMD or the first mode command signal CMD3, the memory controller 110 may provide, through the command address bus 101, the memory apparatus 120 with the data DIN4 or a second portion of the data DIN1 to DIN4. Together with the data DIN4 or the second portion of the data DIN1 to DIN4, the memory controller 110 may provide the memory apparatus 120 with the command clock signal CCK, which is synchronized with the data DIN4. Once the transfer of the data DIN1 to DIN4 is completed, the memory controller 110 may provide the chip enable signal CE # to the memory apparatus 120. The chip enable signal CE # may have a pulse width greater than a predetermined pulse width. Upon receiving the chip enable signal CE #, the memory apparatus 120 may generate a reset signal CBRST based on the chip enable signal CE #. The memory apparatus 120 may detect the pulse width of the chip enable signal CE # to generate the reset signal CBRST. When the pulse width is greater than the predetermined pulse width, the memory apparatus 120 may enable the reset signal CBRST. Based on the reset signal CBRST, the memory apparatus 120 may disable the first data mode signal CBDI and may deactivate the data input/output mode. When the data input/output mode is deactivated, the command address bus 101 may become ready to transfer the command address signal CA<0:1>. In an embodiment, when the data DIN1 to DIN4 is concurrently transmitted through both the data bus 103 and the command address bus 101 during the data input operation, the time interval of transferring the data signal DQ<0:7> through the data bus 103 may be reduced and the time amount required for the data input operation may be decreased. The word “predetermined” as used herein with respect to a parameter, such as a predetermined pulse width, means that a value for the parameter is determined prior to the parameter being used in a process or algorithm. For some embodiments, the value for the parameter is determined before the process or algorithm begins. In other embodiments, the value for the parameter is determined during the process or algorithm but before the parameter is used in the process or algorithm.

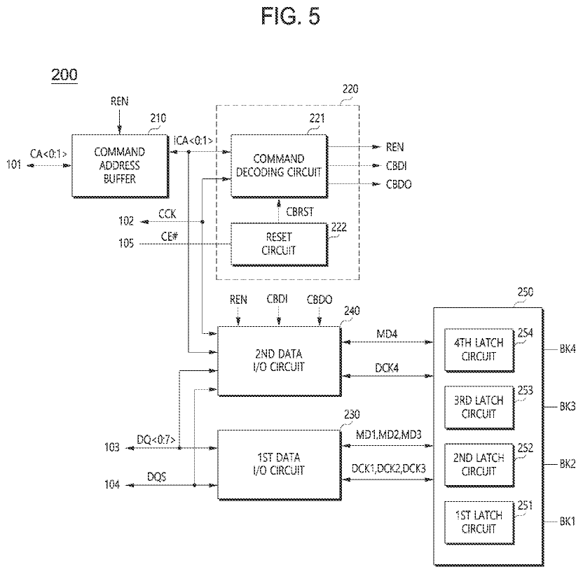

FIG. 4 is a timing diagram illustrating a data output operation of the memory system 100 according to an embodiment. Referring to FIGS. 1 and 4, the memory controller 110 may provide, through the command address bus 101, the memory apparatus 120 with the command address signal CA<0:1>, which includes the data output command signal CMD2, for the data output operation. Together with the command address signal CA<0:1>, the memory controller 110 may provide the command clock signal CCK, which is synchronized with the command address signal CA<0:1>. During the data output operation after the memory controller 110 provides the data output command signal CMD2, the memory apparatus 120 may provide, through the data bus 103, the memory controller 110 with the data DOUT1 to DOUT3, which is the first portion of the data DOUT1 to DOUT4, as the data signal DQ<0:7>. Together with the data DOUT1 to DOUT3 or the first portion of the data DOUT1 to DOUT4, the memory apparatus 120 may provide the data strobe signal DQS, which is synchronized with the data DOUT1 to DOUT3. After providing the data output command signal CMD2, the memory controller 110 may provide, through the command address bus 101, the memory apparatus 120 with the command address signal CA<0:1> including the mode command signal MCMD. Together with the command address signal CA<0:1>, the memory controller 110 may provide the command clock signal CCK, which is synchronized with the command address signal CA<0:1>. Upon receiving the data output command signal CMD2 and the mode command signal MCMD, the memory apparatus 120 may enable a second data mode signal CBDO to activate the data input/output mode. Once the data input/output mode is activated, the command address bus 101 may become ready to transfer a data signal. In one embodiment, the mode command signal MCMD may be replaced by a second mode command signal CMD4 and the memory apparatus 120 may enable the second data mode signal CBDO upon receiving the command address signal CA<0:1> including the second mode command signal CMD4. After receiving the mode command signal MCMD or the second mode command signal CMD4, the memory apparatus 120 may provide, through the command address bus 101, the memory controller 110 with the data DOUT4 or the second portion of the data DOUT1 to DOUT4. Together with the data DOUT4 or the second portion of the data DOUT1 to DOUT4, the memory apparatus 120 may provide the command clock signal CCK, which is synchronized with the data DOUT4. Once the transfer of the data DOUT1 to DOUT4 is completed, the memory controller 110 may provide the memory apparatus 120 with the chip enable signal CE # having a pulse width greater than a predetermined pulse width. Upon receiving the chip enable signal CE #, the memory apparatus 120 may generate the reset signal CBRST based on the chip enable signal CE #. Based on the reset signal CBRST, the memory apparatus 120 may disable the second data mode signal CBDO and may deactivate the data input/output mode. When the data input/output mode is deactivated, the command address bus 101 may become ready to transfer the command address signal CA<0:1>. In an embodiment, when the data DOUT1 to DOUT4 is concurrently transmitted through both the data bus 103 and the command address bus 101 during the data output operation, the time interval of transferring the data signal DQ<0:7> through the data bus 103 may be reduced and the time amount required for the data output operation may be decreased.

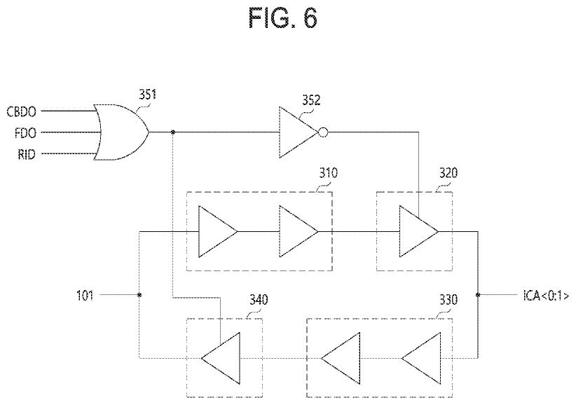

FIG. 5 is a diagram illustrating a configuration of a memory apparatus 200 according to an embodiment. The memory apparatus 200 may be applied as at least one of the plurality of memory dies 121 and 122 of the memory device 120 illustrated in FIG. 1. Referring to FIGS. 1, 3, 4 and 5, the memory apparatus 200 may include a command address buffer 210, a command control circuit 220, a first data input/output (input and output) circuit 230 and a second data input/output (input and output) circuit 240. The command address buffer 210 may be coupled to the command address bus 101. The command address buffer 210 may receive a signal transferred through the command address bus 101 and may generate an internal command address signal ICA<0:1>. The command address buffer 210 may buffer a signal, which is transferred through the command address bus 101, to generate the internal command address signal ICA<0:1>. The command address buffer 210 may receive the internal command address signal ICA<0:1>, may buffer the internal command address signal ICA<0:1> and may output the buffered signal to the command address bus 101. The command address buffer 210 may receive a read enable signal REN. The read enable signal REN may be generated based on the command address signal CA<0:1> and may be enabled when the memory apparatus 200 performs an operation of outputting, to the memory controller 110 of FIG. 1, various information including data. When the read enable signal REN is disabled, the command address buffer 210 may buffer a signal transferred through the command address bus 101 to generate the internal command address signal ICA<0:1>. When the read enable signal REN is disabled and the data input/output mode is deactivated, the command address buffer 210 may buffer the command address signal CA<0:1>, which is transferred through the command address bus 101, to generate the internal command address signal ICA<0:1>. When the read enable signal REN is disabled and the data input/output mode is activated, the command address buffer 210 may buffer the data signal, which is transferred through the command address bus 101, to generate the internal command address signal ICA<0:1>. When the read enable signal REN is enabled, the command address buffer 210 may drive the command address bus 101 based on the internal command address signal ICA<0:1>.

The command control circuit 220 may be coupled to the command address buffer 210 and may receive the internal command address signal ICA<0:1>. Based on the internal command address signal ICA<0:1>, the command control circuit 220 may generate the first data mode signal CBDI and the second data mode signal CBDO. The command control circuit 220 may enable the first data mode signal CBDI when receiving the internal command address signal ICA<0:1> including the data input command signal CMD1 and the mode command signal MCMD. The command control circuit 220 may enable the second data mode signal CBDO when receiving the internal command address signal ICA<0:1> including the data output command signal CMD2 and the mode command signal MCMD. In one embodiment, the command control circuit 220 may enable the first data mode signal CBDI when receiving the internal command address signal ICA<0:1> including the first mode command signal CMD3 and may enable the second data mode signal CBDO when receiving the internal command address signal ICA<0:1> including the second mode command signal CMD4. The command control circuit 220 may receive the chip enable signal CE #. Based on the chip enable signal CE #, the command control circuit 220 may disable the first mode signal CBDI and the second data mode signal CBDO. The command control circuit 220 may detect the pulse width of the chip enable signal CE # to disable the first mode signal CBDI and the second data mode signal CBDO.

The command control circuit 220 may include a command decoding circuit 221 and a reset circuit 222. The command decoding circuit 221 may receive the internal command address signal ICA<0:1> and may decode the internal command address signal ICA<0:1> to generate various internal command signals. The command decoding circuit 221 may also receive the command clock signal CCK through the command clock bus 102 and may latch the internal command address signal ICA<0:1> based on the command clock signal CCK. The command decoding circuit 221 may decode the latched internal command address signal ICA<0:1> to generate various internal command signals. When the internal command address signal ICA<0:1> includes the data output command signal CMD2, the command decoding circuit 221 may generate the read enable signal REN. When the internal command address signal ICA<0:1> includes the mode command signal MCMD, the command decoding circuit 221 may enable one of the first mode signal CBDI and the second data mode signal CBDO. When receiving the data input command signal CMD1 prior to the mode command signal MCMD, the command decoding circuit 221 may enable the first data mode signal CBDI. When receiving the data output command signal CMD2 prior to the mode command signal MCMD, the command decoding circuit 221 may enable the second data mode signal CBDO. In one embodiment, when receiving the internal command address signal ICA<0:1> including the first mode command signal CMD3, the command decoding circuit 221 may enable the first data mode signal CBDI. When receiving the internal command address signal ICA<0:1> including the second mode command signal CMD4, the command decoding circuit 221 may enable the second data mode signal CBDO. The command decoding circuit 221 may receive the reset signal CBRST generated by the reset circuit 222. When the reset signal CBRST is enabled, the command decoding circuit 221 may disable the first mode signal CBDI and the second data mode signal CBDO.

The reset circuit 222 may receive the chip enable signal CE # and may generate the reset signal CBRST. The reset circuit 222 may detect the pulse width of the chip enable signal CE # to generate the reset signal CBRST. When the chip enable signal CE # has a pulse width equal to or greater than a predetermined pulse width, the reset circuit 222 may enable the reset signal CBRST. For instance, the reset circuit 222 may include a counter, may count the enabled duration of the chip enable signal CE # using an arbitrary clock signal and may enable the reset signal CBRST when a result of the counting becomes a threshold value or greater.

The first data input/output circuit 230 may be coupled to both the data bus 103 and the data strobe bus 104. During the data input operation, the first data input/output circuit 230 may receive the data signal DQ<0:7> transferred from the memory controller 110 through the data bus 103. During the data output operation, the first data input/output circuit 230 may output the data signal DQ<0:7> to the memory controller 110 through the data bus 103. During the data input operation, the first data input/output circuit 230 may receive the data strobe signal DQS transferred from the memory controller 110 through the data strobe bus 104. During the data output operation, the first data input/output circuit 230 may output the data strobe signal DQS to the memory controller 110 through the data strobe bus 104. During the data input operation, the first data input/output circuit 230 may receive the data signal DQ<0:7> and may generate memory data MD1 to MD3, which is a first portion of memory data MD1 to MD4. The memory data MD1 to MD4 may include a first memory data signal MD1, a second memory data signal MD2, a third memory data signal MD3 and a fourth memory data signal MD4. The memory data MD1 to MD3, which is the first portion of memory data MD1 to MD4, may include the first memory data signal MD1, the second memory data signal MD2 and the third memory data signal MD3. The memory apparatus 200 may include a plurality of memory banks, which are units of memory cell arrays each capable of independently performing a program operation and a read operation. For example, the memory apparatus 200 may include four memory banks. The first memory data signal MD1 may represent data of the first memory bank BK1. The first memory data signal MD1 may be data stored in the first memory bank BK1. The first memory data signal MD1 may be data retrieved from the first memory bank BK1. The second memory data signal MD2 may represent data of the second memory bank BK2. The second memory data signal MD2 may be data stored in the second memory bank BK2. The second memory data signal MD2 may be data retrieved from the second memory bank BK2. The third memory data signal MD3 may represent data of the third memory bank BK3. The third memory data signal MD3 may be data stored in the third memory bank BK3. The third memory data signal MD3 may be data retrieved from the third memory bank BK3. The fourth memory data signal MD4 may represent data of the fourth memory bank BK4. The fourth memory data signal MD4 may be data stored in the fourth memory bank BK4. The fourth memory data signal MD4 may be data retrieved from the fourth memory bank BK4. The first data input/output circuit 230 may generate the first memory data signal MD1, the second memory data signal MD2 and the third memory data signal MD3 from the data signal DQ<0:7> transferred through the data bus 103. The first data input/output circuit 230 may generate a first data clock signal DCK1, a second data clock signal DCK2 and a third data clock signal DCK3 from the data strobe signal DQS provided together with the data signal DQ<0:7>. The first data input/output circuit 230 may output the first memory data signal MD1 together with the first data clock signal DCK1, may output the second memory data signal MD2 together with the second data clock signal DCK2 and may output the third memory data signal MD3 together with the third data clock signal DCK3. During the data output operation, the first data input/output circuit 230 may receive the memory data MD1 to MD3, which is the first portion of memory data MD1 to MD4, to generate the data signal DQ<0:7>. The first data input/output circuit 230 may receive the first memory data signal MD1, the second memory data signal MD2 and the third memory data signal MD3 and may output, as the data signal DQ<0:7>, the first to third memory data signals MD1 to MD3 through the data bus 103. The first data input/output circuit 230 may receive the first to third data clock signals DCK1, DCK2 and DCK3 together with the first to third memory data signals MD1 to MD3. The first data input/output circuit 230 may output, as the data strobe signal DQS, the first to third data clock signals DCK1, DCK2 and DCK3 through the data strobe bus 104.

The second data input/output circuit 240 may be coupled to an internal bus providing the internal command address signal ICA<0:1> and the data bus 103. The second data input/output circuit 240 may also be coupled to the command clock bus 102 and the data strobe bus 104. The second data input/output circuit 240 may receive the first data mode signal CBDI and the second data mode signal CBDO. Depending on the first data mode signal CBDI and the second data mode signal CBDO, the second data input/output circuit 240 may be selectively coupled to one of the data bus 103 and the internal bus providing the internal command address signal ICA<0:1>. Depending on the first data mode signal CBDI and the second data mode signal CBDO, the second data input/output circuit 240 may be selectively coupled to either the data bus 103 or the data strobe bus 104. When the first data mode signal CBDI and the second data mode signal CBDO are disabled, the second data input/output circuit 240 may be coupled to both the data bus 103 and the data strobe bus 104. The second data input/output circuit 240 may receive the data signal DQ<0:7> through the data bus 103 or may output the data signal DQ<0:7> through the data bus 103. The second data input/output circuit 240 may receive the data strobe signal DQS through the data strobe bus 104 or may output the data strobe signal DQS through the data strobe bus 104.

When either the first data mode signal CBDI or the second data mode signal CBDO is enabled, the second data input/output circuit 240 may be coupled to the command clock bus 102 and the internal bus providing the internal command address signal ICA<0:1>. When the first data mode signal CBDI is enabled, the second data input/output circuit 240 may receive the internal command address signal ICA<0:1> and may generate the fourth memory data signal MD4, which is a second portion of the memory data MD1 to MD4, from the internal command address signal ICA<0:1>. The second data input/output circuit 240 may also receive the command clock signal CCK through the command clock bus 102 and may generate the fourth data clock signal DCK4 from the command clock signal CCK. When the second data mode signal CBDO is enabled, the second data input/output circuit 240 may receive the fourth memory data signal MD4 and may generate the internal command address signal ICA<0:1> from the fourth memory data signal MD4. The second data input/output circuit 240 may also receive the fourth data clock signal DCK4, may generate the command clock signal CCK from the fourth data clock signal DCK4 and may output the command clock signal CCK through the command clock bus 102. The second data input/output circuit 240 may further receive the read enable signal REN. When the read enable signal REN is disabled, the second data input/output circuit 240 may output the fourth memory data signal MD4 and the fourth data clock signal DCK4. When the read enable signal REN is enabled, the second data input/output circuit 240 may receive the fourth memory data signal MD4 and the fourth data clock signal DCK4.

The memory apparatus 200 may further include a cache latch circuit 250. The cache latch circuit 250 may be coupled to the first data input/output circuit 230 and the second data input/output circuit 240 as well as the plurality of memory banks BK1, BK2, BK3 and BK4. During the data input operation, the cache latch circuit 250 may receive the first to third memory data signals MD1, MD2 and MD3 and the first to third data clock signals DCK1, DCK2 and DCK3 from the first data input/output circuit 230. During the data output operation, the cache latch circuit 250 may provide the first data input/output circuit 230 with the first to third memory data signals MD1, MD2 and MD3, and the first to third data clock signals DCK1, DCK2 and DCK3. During the data input operation, the cache latch circuit 250 may receive the fourth memory data signal MD4 and the fourth data clock signal DCK4 from the second data input/output circuit 240. During the data output operation, the cache latch circuit 250 may provide the second data input/output circuit 240 with the fourth memory data signal MD4 and the fourth data clock signal DCK4.

The cache latch circuit 250 may include a plurality of latch circuits. For example, a number of the latch circuits may correspond to a number of the memory data signals and/or a number of the memory banks. The cache latch circuit 250 may include a first latch circuit 251, a second latch circuit 252, a third latch circuit 253 and a fourth latch circuit 254. During the data input operation, the first latch circuit 251 may store, according to the first data clock signal DCK1, the first memory data signal MD1 output from the first data input/output circuit 230. The stored data may be programmed into the first memory bank BK1 during a program operation. During a read operation, the first latch circuit 251 may store data output from the first memory bank BK1. During the data output operation, the first latch circuit 251 may provide, according to the first data clock signal DCK1, the first data input/output circuit 230 with the stored data as the first memory data signal MD1. During the data input operation, the second latch circuit 252 may store, according to the second data clock signal DCK2, the second memory data signal MD2 from the first data input/output circuit 230. The stored data may be programmed into the second memory bank BK2 during a program operation. During a read operation, the second latch circuit 252 may store data output from the second memory bank BK2. During the data output operation, the second latch circuit 252 may provide, according to the second data clock signal DCK2, the first data input/output circuit 230 with the stored data as the second memory data signal MD2. During the data input operation, the third latch circuit 253 may store, according to the third data clock signal DCK3, the third memory data signal MD3 from the first data input/output circuit 230. The stored data may be programmed into the third memory bank BK3 during a program operation. During a read operation, the third latch circuit 253 may store data output from the third memory bank BK3. During the data output operation, the third latch circuit 253 may provide, according to the third data clock signal DCK3, the first data input/output circuit 230 with the stored data as the third memory data signal MD3. During the data input operation, the fourth latch circuit 254 may store, according to the fourth data clock signal DCK4, the fourth memory data signal MD4 from the second data input/output circuit 240. The stored data may be programmed into the fourth memory bank BK4 during a program operation. During a read operation, the fourth latch circuit 254 may store data output from the fourth memory bank BK4. During the data output operation, the fourth latch circuit 254 may provide, according to the fourth data clock signal DCK4, the second data input/output circuit 240 with the stored data as the fourth memory data signal MD4.

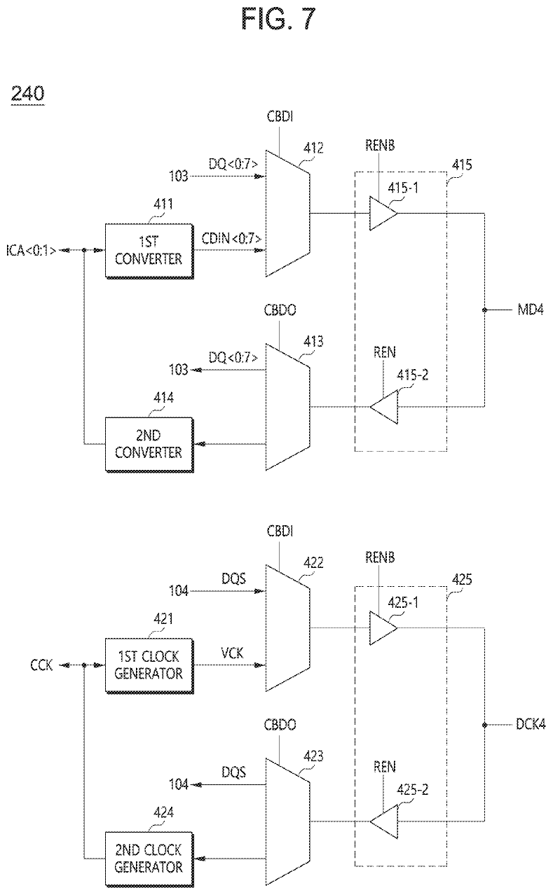

FIG. 6 is a diagram illustrating a configuration of the command address buffer 210 shown in FIG. 5. Referring to FIG. 6, the command address buffer 210 may include a first buffer 310, a first control buffer 320, a second buffer 330 and a second control buffer 340. The first buffer 310 may be coupled to the command address bus 101 and may buffer a signal transferred through the command address bus 101. Based on the second data mode signal CBDO, the first control buffer 320 may selectively output, as the internal command address signal ICA<0:1>, a signal output from the first buffer 310. The first control buffer 320 may receive an inverted signal of the second data mode signal CBDO. When the second data mode signal CBDO is disabled, the first control buffer 320 may couple the first buffer 310 to the internal bus providing the internal command address signal ICA<0:1> and the output signal from the first buffer 310 may be provided as the internal command address signal ICA<0:1>. When the second data mode signal CBDO is enabled, the first control buffer 320 may decouple the first buffer 310 from the internal bus providing the internal command address signal ICA<0:1>. The third buffer 330 may receive the internal command address signal ICA<0:1> and may buffer the internal command address signal ICA<0:1>. The second control buffer 340 may receive the second data mode signal CBDO and may selectively output, based on the second data mode signal CBDO, the output signal from the second buffer 330 to the command address bus 101. When the second data mode signal CBDO is enabled, the second control buffer 340 may couple the second buffer 330 to the command address bus 101 and may output the output signal from the second buffer 330 to the command address bus 101. When the second data mode signal CBDO is disabled, the second control buffer 340 may decouple the second buffer 330 from the command address bus 101.

The command address buffer 210 may further include an OR gate 351 and an inverter 352 and may further receive a feature data output signal FDO and an identification information output signal RID. The memory apparatus 200 may output feature data and identification information of the memory apparatus 200 through the command address bus 101. The feature data output signal FDO may be enabled while the memory apparatus 200 performs an operation of outputting the feature data. The identification information output signal RID may be enabled while the memory apparatus 200 performs an operation of outputting the identification information. The OR gate 351 may receive the second data mode signal CBDO, the feature data output signal FDO and the identification information output signal RID. A signal output from the OR gate 351 may be provided as a control signal of the second control buffer 340. The second control buffer 340 may be modified to selectively couple, based on the output signal from the OR gate 351, the command address bus 101 and the second buffer 330 to each other. The inverter 352 may invert the output signal from the OR gate 351. A signal output from the inverter 352 may be provided as a control signal of the first control buffer 320. The first control buffer 320 may be modified to selectively couple, based on the output signal from the inverter 352, the internal bus providing the internal command address signal ICA<0:1> and the first buffer 310 to each other.

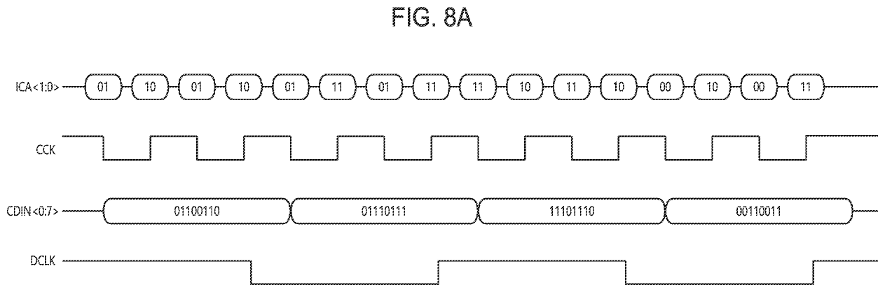

FIG. 7 is a diagram illustrating a configuration of the second data input/output circuit 240 shown in FIG. 5. Referring to FIG. 7, the second data input/output circuit 240 may include a first converter 411, a first selecting circuit 412, a second selecting circuit 413 and a second converter 414. The first converter 411 may receive the internal command address signal ICA<0:1>. The first converter 411 may generate an input conversion data signal CDIN<0:7> from the internal command address signal ICA<0:1>. The first converter 411 may convert a plurality of the internal command address signals ICA<0:1> into the input conversion data signal CDIN<0:7>. For example, the first converter 411 may receive four (4) of the 2-bit signals of the internal command address signals ICA<0:1> and may generate a single input conversion data signal CDIN<0:7>. The first converter 411 may be a 2-bit to 8-bit converter. The first selecting circuit 412 may be coupled to the first converter 411 and the data bus 103 and may receive the first data mode signal CBDI. Based on the first data mode signal CBDI, the first selecting circuit 412 may output one of the signals, which is transferred through the data bus 103, and the input conversion data signal CDIN<0:7>, which is output from the first converter 411. The output signal from the first selecting circuit 412 may be provided as the fourth memory data signal MD4. When the first data mode signal CBDI is disabled, the first selecting circuit 412 may output, as the fourth memory data signal MD4, the data signal DQ<0:7> transferred through the data bus 103. When the first data mode signal CBDI is enabled, the first selecting circuit 412 may output the input conversion data signal CDIN<0:7> as the fourth memory data signal MD4. The second selecting circuit 413 may be coupled to the data bus 103 and the second converter 414 and may receive the fourth memory data signal MD4 and the second data mode signal CBDO. Based on the second data mode signal CBDO, the second selecting circuit 413 may output the fourth memory data signal MD4 to one of the data bus 103 and the second converter 414. When the second data mode signal CBDO is disabled, the second selecting circuit 413 may output the fourth memory data signal MD4 to the data bus 103 and the fourth memory data signal MD4 may be transferred through the data bus 103 as the data signal DQ<0:7>. When the second data mode signal CBDO is enabled, the second selecting circuit 413 may output the fourth memory data signal MD4 to the second converter 414. The second converter 414 may receive the output signal from the second selecting circuit 413 and may convert the output signal from the second selecting circuit 413 into the internal command address signal ICA<0:7>. The second converter 414 may convert the fourth memory data signal MD4, which is a single signal of 8 bits, into four (4) of the 2-bit signals of the internal command address signals ICA<0:1> and may sequentially output the four (4) 2-bit signals of internal command address signals ICA<0:1>. The second converter 414 may be an 8-bit to 2-bit converter.

The second data input/output circuit 240 may further include a first path selecting circuit 415. The first path selecting circuit 415 may be coupled between the fourth memory data signal MD4, and the first selecting circuit 412 and the second selecting circuit 413. The first path selecting circuit 415 may receive the read enable signal REN and may couple, based on the read enable signal REN, a line providing the fourth memory data signal MD4 to one of the first selecting circuit 412 and the second selecting circuit 413. When the read enable signal REN is disabled, the first path selecting circuit 415 may couple the first selecting circuit 412 to the line providing the fourth memory data signal MD4 and may provide, as the fourth memory data signal MD4, a signal output from the first selecting circuit 412. When the read enable signal REN is enabled, the first path selecting circuit 415 may couple the second selecting circuit 413 to the line providing the fourth memory data signal MD4 and may provide the fourth memory data signal MD4 as a signal to be input to the second selecting circuit 413. The first path selecting circuit 415 may include a first buffer 415-1 and a second buffer 415-2. The first buffer 415-1 may receive a complementary signal RENB of the read enable signal REN. When the complementary signal RENB is enabled, i.e., when the read enable signal REN is disabled, the first buffer 415-1 may buffer the output signal from the first selecting circuit 412 to generate the fourth memory data signal MD4. The second buffer 415-2 may receive the read enable signal REN. When the read enable signal REN is enabled, the second buffer 415-2 may buffer the fourth memory data signal MD4 and may provide the buffered signal to the second selecting circuit 413.

The second data input/output circuit 240 may further include a first clock generator 421, a third selecting circuit 422, a fourth selecting circuit 423 and a second clock generator 424. The first clock generator 421 may be a clock dividing circuit. The first clock generator 421 may divide the frequency of the command clock signal CCK to generate a divided clock signal VCK. For example, the first clock generator 421 may divide the frequency of the command clock signal CCK by a quarter (¼) and may create the divided clock signal VCK with a frequency corresponding to a quarter (¼) of the frequency of the command clock signal CCK. The third selecting circuit 422 may be coupled to the first clock generator 421 and the data strobe bus 104 and may receive the first data mode signal CBDI. The third selecting circuit 422 may output, based on the first data mode signal CBDI, one of the data strobe signal DQS, which is transferred through the data strobe bus 104, and the divided clock signal VCK generated by the first clock generator 421. A signal output from the third selecting circuit 422 may be provided as the fourth data clock signal DCK4. When the first data mode signal CBDI is disabled, the third selecting circuit 422 may output, as the fourth data clock signal DCK4, the data strobe signal DQS transferred through the data strobe bus 104. When the first data mode signal CBDI is enabled, the third selecting circuit 422 may output the divided clock signal VCK as the fourth data clock signal DCK4. The fourth selecting circuit 423 may be coupled to the data strobe bus 104 and the second clock generator 424 and may receive the fourth data clock signal DCK4 and the second data mode signal CBDO. The fourth selecting circuit 423 may output, based on the second data mode signal CBDO, the fourth data clock signal DCK4 to one of the data strobe bus 104 and the second clock generator 424. When the second data mode signal CBDO is disabled, the fourth selecting circuit 423 may output the fourth data clock signal DCK4 to the data strobe bus 104 and the fourth data clock signal DCK4 may be output through the data strobe bus 104 as the data strobe signal DQS. When the second data mode signal CBDO is enabled, the fourth selecting circuit 423 may output the fourth data clock signal DCK4 to the second clock generator 424. The second clock generator 424 may receive the output signal from the fourth selecting circuit 423 and may convert, to the command clock signal CCK, the output signal from the fourth selecting circuit 423. The second clock generator 424 may be a clock multiplying circuit. The second clock generator 424 may multiply the frequency of the output signal from the fourth selecting circuit 423 to generate the command clock signal CCK. For example, the second clock generator 424 may generate the command clock signal CCK with a frequency four times the frequency of the output signal from the fourth selecting circuit 423.

The second data input/output circuit 240 may further include a second path selecting circuit 425. The second path selecting circuit 425 may be coupled between the fourth data clock signal DCK4, the third selecting circuit 422 and the fourth selecting circuit 423. The second path selecting circuit 425 may receive the read enable signal REN and may couple, based on the read enable signal REN, a line providing the fourth data clock signal DCK4 to one of the third selecting circuit 422 and the fourth selecting circuit 423. When the read enable signal REN is disabled, the second path selecting circuit 425 may couple the third selecting circuit 422 to the line providing the fourth data clock signal DCK4 and may provide, as the fourth data clock signal DCK4, a signal output from the third selecting circuit 422. When the read enable signal REN is enabled, the second path selecting circuit 425 may couple the fourth selecting circuit 423 to the line providing the fourth data clock signal DCK4 and may provide the fourth data clock signal DCK4 as a signal to be input to the fourth selecting circuit 423. The second path selecting circuit 425 may include a third buffer 425-1 and a fourth buffer 425-2. The third buffer 425-1 may receive the complementary signal RENB of the read enable signal REN. When the complementary signal RENB is enabled, i.e., when the read enable signal REN is disabled, the third buffer 425-1 may buffer the output signal from the third selecting circuit 422 to generate the fourth data clock signal DCK4. The fourth buffer 425-2 may receive the read enable signal REN. When the read enable signal REN is enabled, the fourth buffer 425-2 may buffer the fourth data clock signal DCK4 and may provide the buffered signal to the fourth selecting circuit 423.

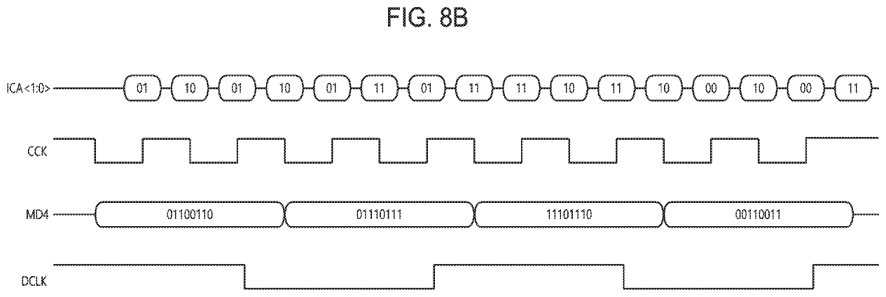

FIGS. 8A and 8B are timing diagrams illustrating an operation of the second data input/output circuit 240 shown in FIG. 7. FIG. 8A illustrates the operation of the second data input/output circuit 240 during a data input operation. Referring to FIGS. 5, 7 and 8A, the read enable signal REN may be disabled when the data input operation is performed and the first data mode signal CBDI is enabled. The first path selecting circuit 415 may couple the first selecting circuit 412 to the line providing the fourth memory data signal MD4 and the second path selecting circuit 425 may couple the third selecting circuit 422 to the line providing the fourth data clock signal DCK4. The first converter 411 may receive the internal command address signal ICA<0:1> and may generate the input conversion data signal CDIN<0:7>. Synchronized with the command clock signal CCK, the 2-bit internal command address signals ICA<0:1> may be input to the first converter 411, which may convert four (4) of the 2-bit signals of the internal command address signals ICA<0:1> into the single 8-bit input conversion data signal CDIN<0:7>. The first converter 411 may generate the 8-bit input conversion data signal CDIN<0:7> each time the first converter 411 receives the four (4) 2-bit signals of the internal command address signals ICA<0:1>. For example, the first converter 411 may generate four (4) of the 2-bit signals of the input conversion data signals CDIN<0:7> from sixteen (16) 2-bit signals of the internal command address signals ICA<0:1>. The first converter 411 may convert the first to fourth internal command address signals (01, 10, 01, 10, 01) into the first input conversion data signal (01100110), may convert the fifth to eighth internal command address signals (01, 11, 01, 11) into the second input conversion data signal (01110111), may convert the ninth to twelfth internal command address signals (11, 10, 11, 10) into the third input conversion data signal (11101110) and may convert the thirteenth to sixteenth internal command address signals (00, 10, 00, 11) into the fourth input conversion data signal (00100011). The first selecting circuit 412 may output the input conversion data signal CDIN<0:7> as the fourth memory data signal MD4. The first clock generator 421 may divide the command clock signal CCK to generate the divided clock signal VCK. The third selecting circuit 422 may output the divided clock signal VCK as the fourth data clock signal DCK4. The fourth latch circuit 254 within the cache latch circuit 250 may receive the fourth memory data signal MD4 and the fourth data clock signal DCK4. Synchronized with the edge of the fourth data clock signal DCK4, the fourth latch circuit 254 may store the fourth memory data signal MD4. When the first data mode signal CBDI is disabled, the first selecting circuit 412 may couple the data bus 103 to the line providing the fourth memory data signal MD4 and the third selecting circuit 422 may couple the data strobe bus 104 to the line providing the fourth data clock signal DCK4. The data signal DQ<0:7> transferred through the data bus 103 may be provided as the fourth memory data signal MD4 and the data strobe signal DQS transferred through the data strobe bus 104 may be provided as the fourth data clock signal DCK4. Synchronized with the fourth data clock signal DCK4, the fourth latch circuit 254 may store the fourth memory data signal MD4.

FIG. 8B illustrates the operation of the second data input/output circuit 240 during a data output operation. Referring to FIGS. 5, 7 and 8B, the read enable signal REN may be enabled when the data output operation is performed and the second data mode signal CBDO is enabled. The first path selecting circuit 415 may couple the second selecting circuit 413 to the line providing the fourth memory data signal MD4 and the second path selecting circuit 425 may couple the fourth selecting circuit 423 to the line providing the fourth data clock signal DCK4. Synchronized with the edge of the fourth data clock signal DCK4, the fourth latch circuit 254 within the cache latch circuit 250 may output the fourth memory data signal MD4. The second selecting circuit 412 may output the fourth memory data signal MD4 to the second converter 414 and the fourth selecting circuit 423 may output the fourth data clock signal DCK4 to the second clock generator 424. The second converter 414 may generate the 2-bit internal command address signals ICA<0:1> from the fourth memory data signal MD4 having 8 bits. The second converter 414 may generate four (4) of the 2-bit signals of the internal command address signals ICA<0:1> from the single 8-bit fourth memory data signal MD4. The second converter 414 may generate sixteen (16) 2-bit signals of the internal command address signals ICA<0:1> from four (4) of the 2-bit signals of the fourth memory data signals MD4. For example, the second converter 414 may convert the firstly provided fourth memory data signal (01100110) into the first to fourth internal command address signals (01, 10, 01, 10), may convert the secondly provided fourth memory data signal (01110111) into the fifth to eighth internal command address signals (01, 11, 01, 11), may convert the thirdly provided fourth memory data signal (11101110) into the ninth to twelfth internal command address signals (11, 10, 11, 10) and may convert the fourthly provided fourth memory data signal (00100011) into the thirteenth to sixteenth internal command address signals (00, 10, 00, 11). The second clock generator 424 may multiply the frequency of the fourth data clock signal DCK4 to generate the command clock signal CCK. When the second data mode signal CBDO is disabled, the second selecting circuit 413 may couple the data bus 103 to the line providing the fourth memory data signal MD4 and the fourth selecting circuit 423 may couple the data strobe bus 104 to the line providing the fourth data clock signal DCK4. The fourth latch circuit 254 may output the fourth memory data signal MD4 having 8 bits and the fourth data clock signal DCK4 having the same frequency as the frequency of the data strobe signal DQS. The fourth memory data signal MD4 may be transferred as the data signal DQ<0:7> through the data bus 103 and the fourth data clock signal DCK4 may be transferred as the data strobe signal DQS through the data strobe bus 104.

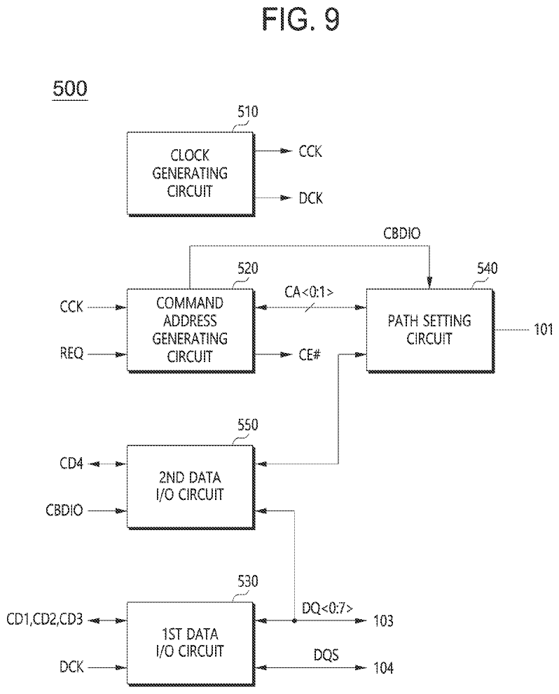

FIG. 9 is a diagram illustrating a configuration of a memory controller 500 according to an embodiment. The memory controller 500 may be applied as the memory controller 110 shown in FIG. 1. Referring to FIGS. 1 and 9, the memory controller 500 may include a clock generating circuit 510, a command address generating circuit 520, a first data input/output (input and output) circuit 530, a path setting circuit 540 and a second data input/output (input and output) circuit 550. The clock generating circuit 510 may generate the command clock signal CCK and the data clock signal DCK. Equipped with a clock generator such as an oscillator, a phase-locked loop circuit, etc., the clock generating circuit 510 may generate the command clock signal CCK and the data clock signal DCK. The clock generating circuit 510 may output the command clock signal CCK through the command clock bus 102. The clock generating circuit 510 may provide the command clock signal CCK to the command address generating circuit 520 and the data clock signal DCK to the first data input/output circuit 530.

The command address generating circuit 520 may receive a request REQ and may generate the command address signal CA<0:1> based on the request REQ. Depending on the request REQ, the command address generating circuit 520 may generate the command address signal CA<0:1>, which includes the data input command signal, the data output command signal, the mode command signal or the first and second mode command signals. The command address generating circuit 520 may receive the command clock signal CCK and may output, in synchronization with the command clock signal CCK, the command address signal CA<0:1>. The command address signal CA<0:1> may be output to the path setting circuit 540. After the output of the command address signal CA<0:1> including the mode command signal, the command address generating circuit 520 may generate a path setting signal CBDIO. After the generating of the command address signal CA<0:1> including the mode command signal and the output of the command address signal CA<0:1>, the command address generating circuit 520 may enable the path setting signal CBDIO. Based on the request REQ, the command address generating circuit 520 may further generate the chip enable signal CE #. The command address generating circuit 520 may transmit the chip enable signal CE # to the memory apparatus 120 through the chip enable bus 105. The command address generating circuit 520 may generate, based on the mode command signal, the chip enable signal CE # with a pulse width greater than or equal to a predetermined pulse width to deactivate the activated data input/output mode.

The first data input/output circuit 530 may be coupled to the data bus 103 and the data strobe bus 104. During a data input operation, the first data input/output circuit 530 may provide, as the data signal DQ<0:7>, the memory apparatus 120 with a first portion CD1, CD2, and CD3 of the controller data CD1, CD2, CD3, and CD4 through the data bus 103. The first portion CD1, CD2, and CD3 of the controller data CD1, CD2, CD3, and CD4 may include a first controller data signal CD1, a second controller data signal CD2 and a third controller data signal CD3. The first data input/output circuit 530 may receive the data clock signal DCK and may output, in synchronization with the data clock signal DCK, the first portion CD1, CD2, and CD3 of the controller data CD1, CD2, CD3, and CD4 to the data bus 103. The first data input/output circuit 530 may generate the data strobe signal DQS based on the data clock signal DCK and may transmit the data strobe signal DQS to the memory apparatus 120 through the data strobe bus 104. During the data output operation, the first data input/output circuit 530 may receive the data signal DQ<0:7> transferred from the memory apparatus 120 through the data bus 103. The first data input/output circuit 530 may receive the data strobe signal DQS transferred from the memory apparatus 120 through the data strobe bus 104. The first data input/output circuit 530 may receive, in synchronization with the data strobe signal DQS, the data signal DQ<0:7> and may generate the first to third controller data signals CD1, CD2 and CD3 from the data signal DQ<0:7>.

The path setting circuit 540 may be coupled between the command address generating circuit 520, the second data input/output circuit 550 and the command address bus 101. The path setting circuit 540 may receive the path setting signal CBDIO and may couple, based on the path setting signal CBDIO, one of the command address generating circuit 520 and the second data input/output circuit 550 to the command address bus 101. When the path setting signal CBDIO is disabled, the path setting circuit 540 may couple the command address generating circuit 520 to the command address bus 101. When the path setting signal CBDIO is enabled, the path setting circuit 540 may couple the second data input/output circuit 550 to the command address bus 101.

The second data input/output circuit 550 may be coupled to the data bus 103 and the path setting circuit 540. The second data input/output circuit 550 may receive the path setting signal CBDIO. The second data input/output circuit 550 may be coupled to either the data bus 103 or the path setting circuit 540 according to the path setting signal CBDIO. When the path setting signal CBDIO is disabled, the second data input/output circuit 550 may be coupled to the data bus 103. During the data input operation, the second data input/output circuit 550 may provide, as the data signal DQ<0:1>, the memory apparatus 120 with a second portion CD4 of the controller data CD1, CD2, CD3 and CD4 through the data bus 103. The second portion CD4 of the controller data CD1, CD2, CD3 and CD4 may include a fourth controller data signal CD4. During the data output operation, the second data input/output circuit 550 may receive the data signal DQ<0:7> transferred through the data bus 103 and may generate the fourth controller data CD4. When the path setting signal CBDIO is enabled, the second data input/output circuit 550 may be coupled to the path setting circuit 540 and the command address bus 101. During the data input operation, the second data input/output circuit 550 may receive the fourth controller data CD4, may convert the fourth controller data CD4 into an output conversion data signal and may output the output conversion data signal to the path setting circuit 540. During the data output operation, the second data input/output circuit 550 may receive, through the path setting circuit 540, a signal transferred through the command address bus 101 and may generate the fourth controller data signal CD4 based on the received signal.

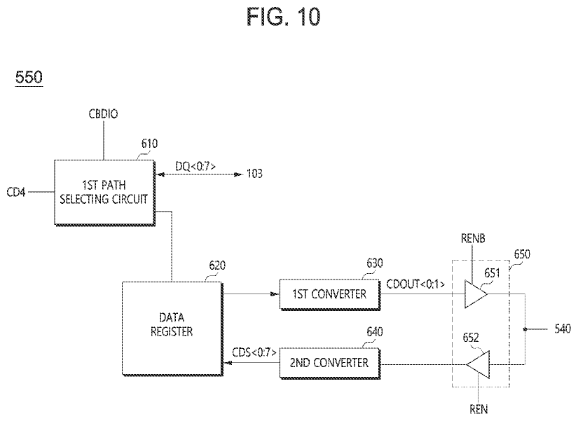

FIG. 10 is a diagram illustrating a configuration of the second data input/output circuit 550 shown in FIG. 9. Referring to FIG. 10, the second data input/output circuit 550 may include a first path selecting circuit 610, a data register 620, a first converter 630 and a second converter 640. The first path selecting circuit 610 may receive the path setting signal CBDIO and may be coupled to the data bus 103, the data register 620 and a line providing the fourth controller data signal CD4. Based on the path setting signal CBDIO, the first path selecting circuit 610 may selectively couple either the data bus 103 or the data register 620 to the line providing the fourth controller data signal CD4. When the path setting signal CBDIO is disabled, the first path selecting circuit 610 may couple the data bus 103 to the line providing the fourth controller data signal CD4. When the path setting signal CBDIO is enabled, the first path selecting circuit 610 may couple the data register 620 to the line providing the fourth controller data signal CD4. The data register 620 may be coupled to the fourth controller data signal CD4 through the first path selecting circuit 610 and may be coupled to the first converter 630 and the second converter 640. The data register 620 may receive the fourth controller data signal CD4 through the first path selecting circuit 610 and may store the fourth controller data signal CD4. During the data input operation, the data register 620 may output the fourth controller data signal CD4 to the first converter 630. During the data output operation, the data register 620 may store a data signal output from the second converter 640. The data register 620 may output, through the first path selecting circuit 610, the stored data as the fourth controller data signal CD4.

The first converter 630 may receive the data signal stored in the data register 620 and may convert the received data signal into an output conversion data signal CDOUT<0:1>. The first converter 630 may convert the 8-bit data signal, which is stored in the data register 620, into the 2-bit output conversion data signal CDOUT<0:1>. The first converter 630 may generate four (4) 2-bit signals of the output conversion data signals CDOUT<0:1> from the single data signal output from the data register 620. The first converter 630 may output the output conversion data signal CDOUT<0:1> to the path setting circuit 540 illustrated in FIG. 9. The output conversion data signal CDOUT<0:1> output from the first converter 630 may be transferred, as a data signal, to the memory apparatus 120 through the command address bus 101. The first converter 630 may include an 8-bit to 2-bit converter. The second converter 640 may receive a signal transferred through the command address bus 101 and the path selecting circuit 540. The second converter 640 may convert the received signal into a storage conversion data signal CDS<0:7>. The second converter 640 may generate the single storage conversion data signal CDS<0:7> from four (4) 2-bit signals of the signals transferred through the command address bus 101. The second converter 640 may provide the storage conversion data signal CDS<0:7> to the data register 620, which may store the storage conversion data signal CDS<0:7>. The second converter 640 may include a 2-bit to 8-bit converter.

The second data input/output circuit 550 may further include a second path selecting circuit 650. The second path selecting circuit 650 may receive the read enable signal REN. The read enable signal REN may be generated by the command address generating circuit 520. For example, the command address generating circuit 520 may generate the read enable signal REN after the generating of the data output command signal CMD2. When the read enable signal REN is disabled, the second path selecting circuit 650 may couple the first converter 630 to the path setting circuit 540. Consequently, the output conversion data signal CDOUT<0:1> output from the first converter 630 may be transferred as a data signal through the command address bus 101. When the read enable signal REN is enabled, the second path selecting circuit 650 may couple the second converter 640 to the path setting circuit 540 and the signal transferred through the command address bus 101 may be input to the second converter 640.

While certain embodiments have been described above, it will be understood to those skilled in the art that the embodiments described are by way of example only. Accordingly, the memory system and the method for transmitting data through command address bus should not be limited based on the described embodiments. Rather, the memory system and the method for transmitting data through command address bus described herein should only be limited in light of the claims that follow when taken in conjunction with the above description and accompanying drawings.

What is claimed is:

1. A memory system comprising:
a memory controller; and
a memory apparatus coupled to the memory controller through a data bus and a command address bus,
wherein one of the memory controller and the memory apparatus is configured to transmit, through the command address bus, data to the other one of the memory controller and the memory apparatus.

2. The memory system of claim 1, wherein the data which the memory controller transmits to the memory apparatus is data to be programmed into the memory apparatus, and the data which the memory apparatus transmits to the memory controller is data to be read from the memory apparatus.

3. The memory system of claim 1, wherein the one of the memory controller and the memory apparatus is configured to transmit, through the data bus, a first portion of the data to the other one of the memory controller and the memory apparatus and configured to transmit, through the command address bus, a second portion of the data to the other one of the memory controller and the memory apparatus.

4. The memory system of claim 3, wherein the first portion of the data, which is transmitted through the data bus, is synchronized with a data strobe signal and the second portion of the data, which is transmitted through the command address bus, is synchronized with a command clock signal.

5. An operating method of a memory system including a memory controller and a memory apparatus, the operating method comprising:
transmitting, by the memory controller, one of a data input command signal and a data output command signal to the memory apparatus through a command address bus;
transmitting, by one of the memory controller and the memory apparatus, a first portion of data to the other one of the memory controller and the memory apparatus through a data bus, and transmitting, by the memory controller, a mode command signal to the memory apparatus through the command address bus; and
transmitting, by the one of the memory controller and the memory apparatus, a second portion of the data to the other one of the memory controller and the memory apparatus through the command address bus.

6. The operating method of claim 5, wherein the transmitting of the first portion of the data includes transmitting, by the one of the memory controller and the memory apparatus, a data strobe signal to the other one of the memory controller and the memory apparatus, the data strobe signal being synchronized with the first portion of the data.

7. The operating method of claim 5, wherein the transmitting of the second portion of the data includes transmitting, by the one of the memory controller and the memory apparatus, a command clock signal to the other one of the memory controller and the memory apparatus, the command clock signal being synchronized with the second portion of the data.

8. The operating method of claim 5,
further comprising, after the transmitting of the mode command signal, activating a data input and output mode, and
wherein the second portion of the data is transmitted after the data input and output mode is activated.

9. The operating method of claim 8, further comprising:
transmitting, by the memory controller, a chip enable signal to the memory apparatus after the transmitting of the second portion of the data; and
deactivating the data input and output (input/output) mode according to the chip enable signal.

10. The operating method of claim 9, wherein the deactivating of the data input/output mode includes detecting, by the memory apparatus, a pulse width of the chip enable signal to deactivate the data input and output mode.

11. A memory system comprising:
a memory controller; and
a memory apparatus coupled to the memory controller through a data bus and a command address bus,
wherein the memory controller is configured to transmit, during a data input operation, data to be stored in the memory apparatus to the memory apparatus through the data bus and the command address bus, and
wherein the memory apparatus is configured to transmit, during a data output operation, the data read from the memory apparatus to the memory controller through the data bus and the command address bus.

12. The memory system of claim 11, wherein the memory apparatus includes:
a command address buffer configured to generate an internal command address signal from a signal transferred through the command address bus or configured to output the internal command address signal through the command address bus;
a command control circuit configured to generate a first data mode signal and a second data mode signal based on the internal command address signal; and
a first data input and output circuit configured to generate, based on the first data mode signal, a first memory data signal from the internal command address signal and configured to generate, based on the second data mode signal, the internal command address signal from the first memory data signal.

13. The memory system of claim 12, wherein the command address buffer is configured to:
buffer, when the second data mode signal is disabled, a signal transferred through the command address bus to generate the internal command address bus, and
buffer, when the second data mode signal is enabled, the internal command address signal to output the buffered internal command address signal through the command address bus.

14. The memory system of claim 13, wherein the command control circuit is configured to:
enable the first data mode signal when receiving the internal command address signal including a data input command signal and the mode command signal, and
enable the second data mode signal when receiving the internal command address signal including a data output command signal and the mode command signal.

15. The memory system of claim 13,
wherein the mode command signal includes a first mode command signal and a second mode command signal, and
wherein the command control circuit is configured to:
enable the first data mode signal when receiving the internal command address signal corresponding to the first mode command signal, and
enable the second data mode signal when receiving the internal command address signal corresponding to the second mode command signal.

16. The memory system of claim 12, wherein the command control circuit includes:
a command decoding circuit configured to decode the internal command address signal to enable the first data mode signal and the second data mode signal and configured to disable, according to a reset signal, the first data mode signal and the second data mode signal; and
a reset circuit configured to generate the reset signal according to a chip enable signal.

17. The memory system of claim 16, wherein the reset circuit is configured to generate the reset signal by detecting a pulse width of the chip enable signal.

18. The memory system of claim 12,
wherein the first data input and output circuit includes:
a first converter configured to generate a converted input data signal from the internal command address signal;
a first selecting circuit configured to output, according to the first data mode signal, one of the converted input data signal and a data signal, which is transferred through the data bus, as the first memory data signal; and
a second selecting circuit configured to output, according to the second data mode signal, the first memory data signal to the data bus or to an input signal of the second converter, and
wherein the second converter is configured to generate the internal command address signal from the first memory data signal.

19. The memory system of claim 18, wherein the first data input and output circuit further includes a path selecting circuit configured to:
coupling, when a read enable signal is disabled, a line providing an output signal of the first selecting circuit to a line providing the first memory data signal, and
coupling, when the read enable signal is enabled, the line of the first memory data signal to a line providing an input signal of the second selecting circuit.

20. The memory system of claim 12,
wherein the first data input and output circuit includes:
a first clock generator configured to divide a frequency of a command clock signal to generate a divided clock signal;
a third selecting circuit configured to output, as a data clock signal, one of the divided clock signal and a data strobe signal according to the first data mode signal; and
a fourth selecting circuit configured to output, according to the second data mode signal, the data clock signal as one of the data strobe signal and an input signal to be input to a second clock generator, and
wherein the second clock generator is configured to multiply a frequency of the data clock signal to generate the command clock signal.

21. The memory system of claim 12, further comprising a second data input and output circuit configured to:
generate, in synchronization with a data strobe signal, a second memory data signal from a data signal transferred through the data bus,
output, in synchronization with the data strobe signal, the second memory data signal through the data bus.

22. The memory system of claim 12, wherein the memory controller includes:
a command address generating circuit configured to generate a command address signal;
a first data input and output circuit configured to:
couple, when a path setting signal is disabled, a line providing a first controller data signal to the first data bus,
generate, when the path setting signal is enabled, an output conversion data signal from the first controller data signal, and
generate the first controller data signal from a signal transferred through the command address bus; and
a path setting circuit configured to couple, according to the path setting signal, the command address bus to one of the command address generating circuit and the first data input and output (input/output) circuit.

23. The memory system of claim 22, wherein the first data input and output circuit includes:
a first path selecting circuit configured to couple, according to the path setting signal, the line providing the first controller data signal to one of the data bus and a data register;
a first converter configured to generate the output conversion data signal from a data signal stored in the data register;
a second converter configured to generate a storage conversion data signal from a signal transferred through the command address bus to provide the storage conversion data signal to the data register; and
a second path selecting circuit configured to couple, according to a read enable signal, the path setting circuit to one of the first converter and the second converter.

24. The memory system of claim 22, wherein the memory controller further includes a second data input and output circuit configured to:
generate, in synchronization with a data strobe signal, a second controller data signal from a data signal transferred through the data bus, and
output, in synchronization with the data strobe signal, the second controller data signal through the data bus.
